(19) United States
(12) Patent Application Publication
(10) Pub. No.: US 2009/0194605 A1
(43) Pub. Date: Aug. 6, 2009

(54) Method for creating a gas-drop jet and a device for its implementation

(76) Inventor: Igor Aleksandrovich Lepeshinsky, Moscow (RU)

Correspondence Address: MCDERMOTT WILL & EMERY LLP, 600 13TH STREET, N.W., WASHINGTON, DC, 20005-3096, US

(21) Appl. No.: 11/920,746

(22) PCT Filed: May 23, 2006
(86) PCT No.: PCT/RU2006/000259

§ 371 Date: Mar. 6, 2009

(30) Foreign Application Priority Data
Jun. 8, 2005 (RU) 2005117639

(51) Int. Cl. B05B 7/04; B05B 7/24; F02C 3/04

(52) U.S. Cl. 239/8; 239/128; 60/784

(57) ABSTRACT

The proposed group of inventions relates to methods and devices for creating a gas-drop jet used for fire-fighting.

The proposed inventions may be used for suppressing turbary, forest fires, fires in high-altitude buildings, etc. since they provide an increase in speed of extinguishing jet and a long range, thus raising the extinguishing properties of a jet.

The aims of the proposed group of inventions are as follows:
Creating an efficient stand-alone modular installation, allowing to obtain a jet of extinguishing fluid with an increased range and speed of flight and to use it independently or and in a complete set with various delivery vehicles (a car, a plane, a helicopter, etc.);
Improvement of the thermodynamic cycle of the fire-fighting installation using gas turbine engine, and increase of its efficiency;
Replacement of air containing an oxidizer (oxygen), used for creating a gas-drop jet, by products of combustion that are containing almost no oxidizer.

The technical result in the proposed invention is obtained due to making a method for creating a gas-drop jet, including supply of fluid and gas working medium created using a gas turbine engine.

The technical result in the proposed invention is obtained due to making a method for creating a gas-drop jet, where according to present invention, the turbine of the gas turbine engine is supplied with at least one outlet of gas working body located between its stages and connected to at least one heat exchanger and a cooler for the gas working medium of the installation.

A method for creating a gas-drop jet and a device for its implementation The proposed group of inventions relates to methods and devices for creating a gas-drop jet used for fire-fighting.

The proposed group of inventions may be used in free-running devices working that are using the technology for obtaining highly concentrated jets, featuring a long range and fine-dispersion structure of drops.

The proposed inventions may be used for suppressing turbary, forest fires, fires in high-altitude buildings, etc. since they provide an increase in speed of extinguishing jet and a long range, thus raising the extinguishing properties of a jet.

There is a known method for creating a gas-drop jet, including fluid and gas stream supply, dispersion of the fluid, mixing the dispersed fluid with the gas stream and acceleration of the obtained biphase gas-drop stream (RF Patent No 2107554, C1. A62C 31/02,1998).

The drawbacks of the known method are the limited nature of used ways of shaping the biphase stream that is lowering the efficiency of a gas-drop jet, in particular, losses of kinetic energy of fluid when shaping the disperse stream of gas-drop structure.

The method most close from the point of view of technical essence to the offered engineering solution is the method for creating a gas-drop jet, including the supply of fluid and gas stream, dispersion of fluid, mixing the dispersed fluid with the gas stream and acceleration of the obtained biphase gas-drop stream (see the RF patent No 2243036 C1. B05B7/00,2004).

There is a known installation for fire-fighting, for example, to be mounted on a car consisting of a tank for extinguishing fluid, a high pressure pump connected to the tank and supplying the fluid to a fire-hose barrel (see the <<Fire machines>> catalogue, 2002).

The drawback of the known design is the use of air that supports the seat of fire.

The closest engineering solution to the proposed one is the installation including an assembly frame, a gas turbine engine consisting of a compressor, a combustion chamber and a turbine having, at least, two stages and a target nozzle, its fuel system, a fuel tank, mechanically connected to the engine, an electro generator and water pumps of high, average and low pressure, an accumulator bin for the fluid, a water-intaking device connected to the latter and made as a receiving hose connected to the low pressure pump, a rotary fire-hose barrel, its rotation drive, a control system which is connected to the rotation drive of the fire-hose barrel and to the electro generator, pipelines, a unit for mixing the fluid and gas in the fire-hose barrel, connected to an inlet for fluid supply and having the outlets for gas working medium supply, a foaming device connected by a pipeline to the unit of its supply into the unit for mixing fluid and gas working medium of the fire-hose barrel (RF patent No 2236876, C1. A62C3/00,2004.)

The known installation has the following drawbacks:
Low effectivity because of low efficiency of use of gas turbine installation since the air used in the fire system that is drawn from the main compressor or from an additional compressor, does not make work of expansion in the turbine.

The heat contained in the air after the compressor (the temperature of the air after the compressor may range from 500 to 700K) is irrevocably lost, it is heating up the water and together with it is thrown out in the atmosphere. The warm from the engine nozzle is also lost.

the use of air as working gas: the air used for dispersal of drops, while getting in the heat source, is a good oxidizer contributory to burning.

The aims of the proposed group of inventions are as follows: creating an efficient stand-alone modular installation, allowing to obtain a jet of extinguishing fluid with an increased range and speed of flight and to use it independently or and in a complete set with various delivery vehicles (a car, a plane, a helicopter, etc.);

Improvement of the thermodynamic cycle of the fire-fighting installation using gas turbine engine, and increase of its efficiency, replacement of air containing an oxidizer (oxygen), used for creating a gas-drop jet, by products of combustion that are containing almost no oxidizer.

The technical result in the proposed invention is obtained due to making a method for creating a gas-drop jet, including supply of fluid and gas working medium created using a gas turbine engine, dispersing the fluid, mixing the dispersed fluid with the gas working medium and accelerating the obtained biphase gas-drop jet in which, according to the invention, the partly used combustion materials from the gas turbine engine are used as a gas working medium.

Cooling the gas working medium before its mixing with the dispersed fluid allows to get an additional work on the turbine by injecting the fluid which have been heated up in heat exchangers, supplying an additional working medium (evaporated fluid) in the combustion chamber and getting an additional work in the turbine.

The technical result in the proposed is obtained due to creating an installation containing a mounting frame, a gas turbine engine consisting of a compressor, a combustion chamber, a turbine having at least two steps and a target nozzle, its fuel system, a fuel tank mechanically connected to the engine, an electro generator and water pumps of high, average and low pressure, an accumulator bin, a water-in taking device connected to the said bin, where the water-in taking device is made as a receiving hose connected to the low pressure pump, a rotary fire-hose barrel, its rotation drive, a control system which is connected to the rotation drive of the fire-hose barrel and to the electro generator, pipelines, a unit for mixing the fluid and gas in the fire-hose barrel, connected to an inlet for fluid supply and having the inlets for gas working medium supply, a foaming device connected by a pipeline to the unit of its supply into the unit for mixing fluid and gas working medium of the fire-hose barrel, where according to the present invention, the turbine of the gas turbine engine is equipped with at least one outlet of the gas working medium located between its stages and connected at least to two heat exchangers and a cooler for the gas working medium of the installation.

The invention is also characterized by the fact that the fluid circuit of one of heat exchangers mounted in the exhaust nozzle of the engine is connected by its inlet to the high pressure water pump and by its output to the second heat exchanger mounted in the circuit of gas working medium, to the outlet of the gas working medium between its stages of the turbine, thus the inlet of the fluid circuit of the second heat exchanger is connected to the outlet of the cooling fluid from the first heat exchanger which is connected to the inlet in the combustion chamber, thus the circuit of gas working medium is connected to the outlet of the gas working medium between its stages of the turbine which is connected to the second heat exchanger connected by the outlet of gas working medium to the device for cooling the gas working medium.

The invention is also characterized by that the device for cooling the gas working medium is connected to the heat exchanger to the mixing chamber of the fire-hose barrel, and also to the fluid outlet from the average pressure pump.

The presence of heat exchangers allows to get additional work in the turbine since they are cooling the gas working medium and are supplying thermal energy to the fluid. The water in the heat exchanger overheats or evaporates, and then the obtained vapor-liquid working medium is supplied to the combustion chamber where it is being injected, thus the additional working medium is formed, allowing to get additional work in the turbine.

Use of fuel from the gas turbine engine as the heat-carrier in heat exchangers also allows to bring down the overall consumption of fuel thus making the installation more energy-conserving.

In this case, the fuel is supplied from the fuel system of the engine to the heat exchangers, and after heating and evaporation it is supplied to the combustion chamber.

Using the gas turbine engine in the proposed installation as a power source allows to obtain a high-energy gas working medium as products of combustion and to raise the overall performance of the resulting gas-drop jet.

The patent research has shown that there are no known engineering solutions with the specified set of essential features, in similar methods for creating a gas-drop jet and devices for their implementation, i.e. the group of proposed solutions corresponds to the novelty criterion.

After analyzing the known analogues and the prototype there we no revealed proposals with the set of essential features stated in the claims of the invention that means that for the experts engaged in methods for creating a gas-drop jet and devices for their implementation, they obviously do not follow from the state of the art and, hence, meet the criterion of the “level of invention”.

The authors believe that the information stated in the materials of the application is enough for practical implementation of the group of inventions.

The proposed group of inventions, namely, the method for creating a gas-drop jet and the device for its implementation, is explained using the following description of the method and design, and the figures, where:

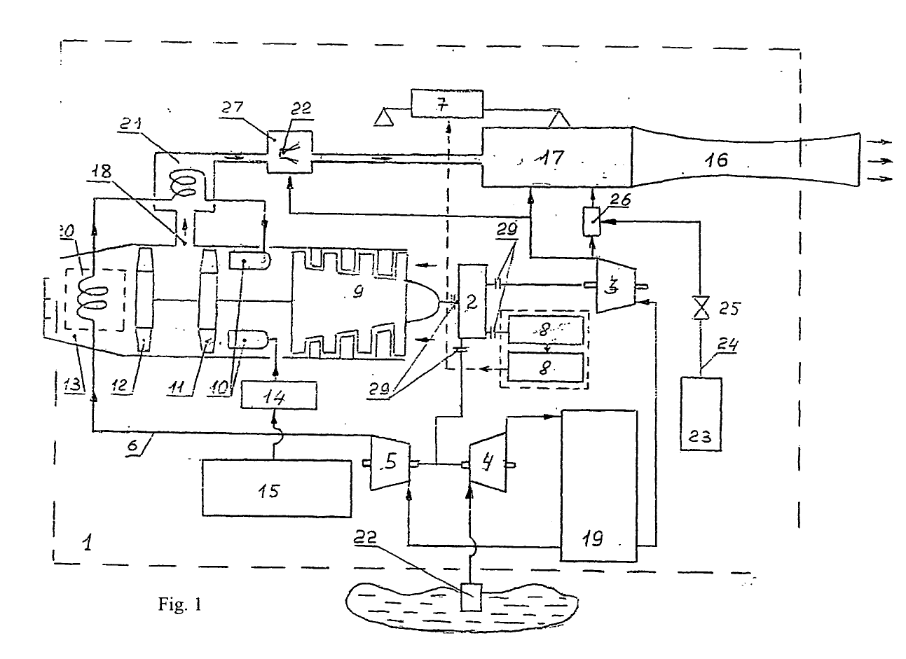

In FIG. 1—the circuit of installation for creating a gas-drop jet is shown. The installation for creating a gas-drop jet, includes the mounting frame 1, with a gas turbine engine connected to it mechanically, e.g. using a transmission (not shown in the FIGURE), an average pressure water pump 2, a low pressure water pump 3, a high pressure water pump 4 and an electro generator 5, a water-in taking device, pipelines 6, a drive for rotating the fire-hose barrel 7, the control system of installation 8 connected to the electro generator 5 and to the drive for rotating the fire-hose barrel 7.

The gas turbine engine includes the compressor 9, the combustion chamber 10, the turbine consisting of at least two stages 11 and 12, the target nozzle 13, the fuel system 14 with the fuel tank 15. Thus the engine is connected to the fire-hose barrel made as a gas dynamic nozzle 16, the device for mixing the fluid and the gas working medium (mixing chamber) 17 connected to it.

The fire-hose barrel may be mounted separately from the mounting frame 1 depending on conditions of layout of the installation on the delivery vehicle, but it is necessarily connected through the mixing chamber 17 by a pipeline to the average pressure pump 2, to the outlet of gas working medium 18 that is drawn between the stages 11 and 12 of the turbine, and to the rotation drive of the fire-hose barrel 8.

For reducing the energy losses the high pressure pump 4 powered by the transmission, is connected by the inlet pipeline to a reserve fluid accumulator bin 19, and by the target pipeline to the heat exchanger 20 mounted in the target nozzle of the engine 13.

The outlet of the pipeline from the heat exchanger 20 is connected to the inlet of heat exchanger 21 mounted in the outlet of gas working medium 18, the outlet of the heat-carrier from the heat exchanger 21 is connected to the combustion chamber 10 where the overheated water, or vapors, or their mix are supplied. The products of combustion from the heat exchanger 21 are supplied to the heat exchanger 20 connected by the pipeline to the outlet from the average pressure water pump 2 and by a channel to the mixing chamber 17 for cooled products of combustion with vapors of water.

It is possible to use fuel instead of water as the heat-carrier. In this case, the heat-carrier (fuel) is supplied from the unit 14.

The water-in taking device is made as a receiving hose 22 connected to low pressure pump 5, connected to the gas turbine engine and is connected through back-pressure valves to the fluid accumulator bin 19.

The foaming device connected to the device for mixing fluid and gas of the fire-hose barrel is made as a tank with a foam former 23 connected by the pipeline 24 to the choking tap 25 and to its supply unit 26 in the mixing chamber 17.

The proposed installation for creating a gas-drop jet operates as follows:

Preliminary the self-contained installation is to be prepared for work by filling the tanks 23 with foam former, the bin 19 with fluid, and the tank 15 with fuel.

It is to be fixed to a delivery vehicle, e.g. a car or a helicopter and delivered to the area of fire extinguishing. The installation is to be placed at a necessary distance from the seat of fire.

Next the gas turbine engine launches which actuates through mechanical transmission the average pressure pump 2, the high pressure pump 4 and the electro generator 5.

The high pressure pump delivers water to the heat exchanger 20 connected to the heat exchanger 21, and from the heat exchanger 21 to the combustion chamber 10 of the gas turbine engine.

The average pressure pump delivers through the pipelines the extinguishing fluid (water) from the fluid accumulator bin 19 to the mixing device of fluid and gas working medium 17. The gas working medium (products of combustion) are also supplied to the mixing device 17, the said gas working medium is being drawn between the stages of the turbine through the channel 18, it is necessary for dispersion of fluid and dispersal of the biphase gas-drop stream.

For maximal covering of the fire area, the fire-hose barrel rotates in horizontal and vertical planes using the control system of installation 9 and the rotation drive 8.

In case of suppressing inflammable, combustible liquids, the foam former from the tank 23 is applied. For this purpose, the choking tap 25 is opened, and the foam former is supplied using the pipeline 24 through its supply unit 26 of an e.g. ejecting type, to the mixing device 17. Mixing of a liquid and a gas working medium is done using any known method (for example as in the prototype) and the applicant does not apply for novelty.

Mixing up with the extinguishing fluid the foam former creates on the output of the fire-hose barrel the foam that covers the seat fire, stopping the inflow of oxygen that is necessary for burning.

When using all the stock of the extinguishing fluid (water) in the accumulator bin 19 it is possible to fill it with an additional quantity of fluid from an external source, for example, a reservoir or a road tanker.

In the first case, (reservoir) the low pressure pump 3 driven by the gas turbine engine, through the half-coupling 29, turns on, where the pump 3 is connected to the receiving hose 22 that is connected to the fluid accumulator bin 19 through back-pressure valves, and begin pumping the liquid starts.

In case of refill of fluid from the fire machine the low pressure pump is not used since the machine has its own pump.

In this situation, the receiving hose 18 is connected to the target channel of the fire machine, and through the back-pressure valves will be directly connected to the fluid accumulator bin 19.

Use of bleed of gas working medium from the space between the turbine stages allows to bring down the power expenses by 8 to 20% depending on system parameters.

The estimation of use of the gas turbine engine shows the following parameters:

Air charge G=9 kg/sec

Compression ratio π=9

Temperature of gas working medium in front of turbine T−=1190K

Waste of energy in the form of heat when using the engine with the given parameters are reduced by 13 to 15% depending on the overall performance of heat exchangers.

1. A method for creating a gas-drop jet, including fluid and gas working medium supply, created using a gas turbine engine, dispersion of the fluid, mixing the dispersed fluid with the gas working medium and accelerating the obtained biphase gas-drop stream whereas the partly used combustion materials from the gas turbine engine are used as a gas working medium.

2. A method as claimed in claim 1 whereas the gas working medium is cooled before its mixing with the dispersed fluid.

3. An installation for creating the gas-drop jet, including a mounting frame, a gas turbine engine consisting of a compressor, a combustion chamber and a turbine having, at least, two stages and a target nozzle; its fuel system, a fuel tank, an electro generator and water pumps of high, average and low pressure mechanically connected to the said generator using the engine, a fluid accumulator bin, a water-in taking device connected to the said accumulator bin, made as a receiving hose, connected to the low pressure pump, a rotary fire-hose barrel, its rotation drive, a control system which is connected to the rotation drive of the fire-hose barrel and to the electro generator, pipelines, a chamber for mixing fluid and the gas working medium of the fire-hose barrel, connected to an inlet for fluid supply and having the outlets for gas working medium supply, a foaming device connected by a pipeline to the unit of its supply into the unit for mixing fluid and gas working medium of the fire-hose barrel whereas the turbine of the gas turbine engine is equipped with at least one outlet of gas working medium placed between its stages and connected, at least, to one heat exchanger and to the device for cooling the gas working medium of the installation.

4. An installation as claimed in claim 3, whereas the fluid circuit of one of the heat exchangers mounted in the exhaust nozzle of the engine is connected to by its inlet to the high pressure water pump and by its output to the second heat exchanger mounted in the circuit of gas working medium, to the outlet of the gas working medium between its stages of the turbine, thus the inlet of the fluid circuit of the second heat exchanger is connected to the outlet of the cooling fluid from the first heat exchanger which is connected to the inlet in the combustion chamber, thus the circuit of gas working medium is connected to the outlet of the gas working medium between its stages of the turbine which is connected to the second heat exchanger connected by the outlet of gas working medium to the device for cooling the gas working medium.

5. An installation as claimed in claim 3, whereas the device for cooling the gas working medium is connected to one of heat exchangers and to the mixing chamber of the fire-hose barrel, and also to the fluid outlet from the average pressure pump.

6. An installation as claimed in claim 3, whereas the fuel of the gas turbine engine is used as heat-carrier in the heat exchanger.
